(19) United States
(12) Patent Application Publication
(10) Pub. No.: US 2026/0186882 A1
(43) Pub. Date: Jul. 2, 2026

(54) LOGLINE ENRICHMENT FOR ERROR ANALYSIS

(71) Applicant: International Business Machines Corporation, Armonk, NY (US)

(72) Inventors: Karan BHUKAR, Jaipur (IN); Pranjal GUPTA, Bhilai (IN); Debanjana KAR, Kolkata (IN); Harshit KUMAR, Delhi (IN); Prateeti MOHAPATRA, Bangalore (IN); Suranjana SAMANTA, Bangalore (IN); Pooja AGGARWAL, Bengaluru (IN); Seema NAGAR, Bangalore (IN)

(21) Appl. No.: 19/004,212

(22) Filed: Dec. 27, 2024

(51) Int. Cl. G06F 11/07

(52) U.S. Cl. CPC G06F 11/0769; G06F 11/0781; G06F 11/079

(57) ABSTRACT

In some implementations, a computing device may receive a set of loglines and a problem description associated with the set of loglines. The computing device may identify clusters of loglines, from the set of loglines, based at least in part on structures of the set of loglines. The computing device may identify key indicators associated with a subset of loglines of respective clusters of loglines. The computing device may apply the key indicators to the respective clusters. The computing device may perform error analysis on the set of loglines based at least in part on the key indicators.

### BACKGROUND

Software support systems may rely on telemetry data (e.g., loglines and traces) to detect and correct errors. For example, a computing device may receive a data dump associated with a problem (e.g., indicated as a problem description). The size of these data dumps may be between 10 and hundreds of gigabytes of data in some computing environments. This amount of data may be unwieldy for an error correction engineer (e.g., software engineer or computer programmer, among other examples) to correct the error with an acceptable latency to maintain an acceptable user experience. Additionally, the data dumps may include loglines from a time span of months or years-worth of data. Further, the data dumps may be associated with numerous files that may cause the error correction engineer to manually search through computer systems to access or correct potential errors.

In some examples, an error correction engineer be unaware of what datafile caused a diagnostic process to initiate. After identifying the datafile to start diagnosis, the error correction engineer may discover that one file may contain data from many sessions or threads (e.g., associated with one or multiple entities), the datafile may contain thousands of logs or traces, or a majority of the logs or traces may be normal (e.g., 90%+), among other examples. These situations may cause the error correction engineer to use computing resources to review files, access the data fails, and search for errors to correct. Additionally, a computer program may operate in an error state for a relatively long period of time because of a time it takes for the error correction engineer to discover and correct errors, which may consume computing resources and power resources and may worsen user experience.

### SUMMARY

In some implementations, a method comprises receiving a set of loglines and a problem description associated with the set of loglines. The method comprises identifying clusters of loglines, from the set of loglines, based at least in part on structures of the set of loglines. The method comprises identifying key indicators associated with a subset of loglines of respective clusters of loglines. The method comprises applying the key indicators to the respective clusters. The method also comprises performing error analysis on the set of loglines based at least in part on the key indicators.

In some implementations, a computer program product comprises one or more computer readable storage media and program instructions collectively stored on the one or more computer readable storage media. The program instructions comprise program instructions to receive a set of loglines and a problem description associated with the set of loglines. The method comprises program instructions to identify clusters of loglines, from the set of loglines, based at least in part on structures of the loglines. The method comprises program instructions to identify key indicators associated with a representative logline of a cluster of loglines. The method comprises program instructions to apply the key indicators to the cluster of loglines. The method comprises program instructions to perform error analysis on the set of loglines based at least in part on the key indicators.

In some implementations, a system comprises one or more devices configured to receive a set of loglines and a problem description associated with the set of loglines. The one or more devices are configured to identify, from the set of loglines, a first cluster of loglines and a second cluster of loglines based at least in part on structures of the set of loglines. The one or more devices are configured to identify one or more first key indicators associated with a first subset of loglines of the first cluster and one or more second key indicators associated with a second subset of loglines of the second cluster. The one or more devices are configured to apply the one or more first key indicators to the first cluster and the one or more second key indicators to the second cluster. The one or more devices are configured to perform error analysis on the first cluster based at least in part on the one or more first key indicators and on the second cluster based at least in part on the one or more second key indicators.

### BRIEF DESCRIPTION OF THE DRAWINGS

FIGS. 1A-1I are diagrams of an example implementation described herein.

FIG. 2 is a diagram of an example computing environment in which systems and/or methods described herein may be implemented.

FIG. 3 is a diagram of example components of one or more devices of FIGS. 1 and 2.

FIGS. 4-6 are flowcharts of example processes associated with logline enrichment for error analysis.

### DETAILED DESCRIPTION

The following detailed description of example implementations refers to the accompanying drawings. The same reference numbers in different drawings may identify the same or similar elements.

Software support systems may rely on telemetry data (e.g., loglines and traces) to detect errors and provide information to an error correction engineer for correction. In some examples, a computing device may receive a data dump and a problem description. A size of data within the data dump may be too large for an error correction engineer to manually detect errors and correct the errors with an acceptable latency to maintain an acceptable user experience. Additionally, the data dumps may include loglines from a large enough period of time to make it difficult for the error correction engineer to identify the errors, find correlation between errors, and correct the errors. Further, the data dumps may be associated with multiple files that may cause the error correction engineer search through computer systems to access or correct potential errors. These situations may cause the error correction engineer to use computing resources to review files, access the data fails, and search for errors to correct. Additionally, a computer program may operate in an error state for a relatively long period of time because of a time it takes for the error correction engineer to discover and correct errors, which may consume computing resources and power resources and may worsen user experience.

In some aspects described herein, a computing device may perform relevant file identification on a data dump associated with error analysis. The computing device may perform golden signal (GS) classification, fault category (FC) prediction, or entity detection and classification. The computing device may perform anomaly detection (e.g., using GS and FC information). The computing device may perform a summarize (e.g., microscopic) view of windows and raw data. In some aspects, the computing device may perform causal relationship detection, ranking of anomalous windows (e.g., for prioritization of error correction), or summarization of windows, among other examples.

In some aspects, the computing device may perform on-demand log slicing, including enriching individual loglines with a type of golden signal present, a type of fault it represents, other problem loglines the logline is causing, and importance based at least in part on a time of occurrence or what is happening in a computer system around an occurrence time of an error. The computing device may use the enriched data to produce a diagnosis score for a logline, which can be provided to an error correction engineer (e.g., a site reliability engineer (SRE)). The computing device may also provide a summary for anomalous windows of loglines or a group of anomalous windows of loglines.

The computing device may perform one or more methods for file determination from a ticket data for a given ticket description; GS classification and FC prediction; entity detection and classification; anomaly detection using GS or FC distribution; computing causal relationship graph using GS, FS, and an entity detected; and importance score computation for ranking windows, among other examples. In some aspects, one or more of these methods may be used to provide enriched loglines to another computing device (e.g., associated with an error correction engineer) for error analysis or error correction.

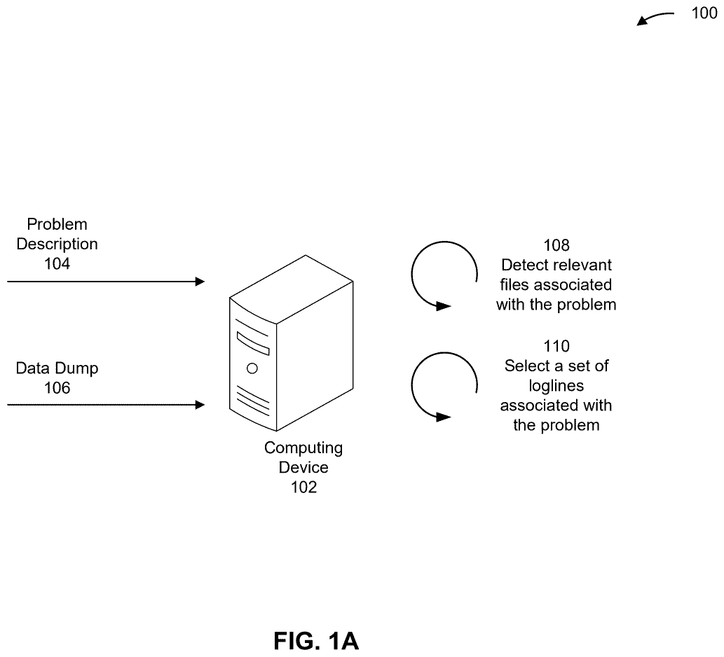

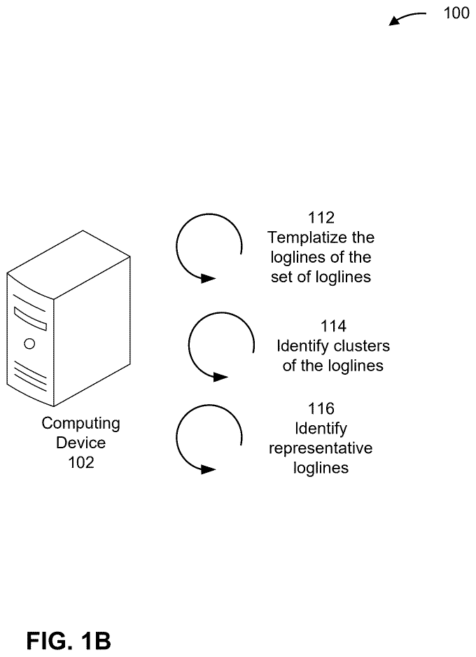

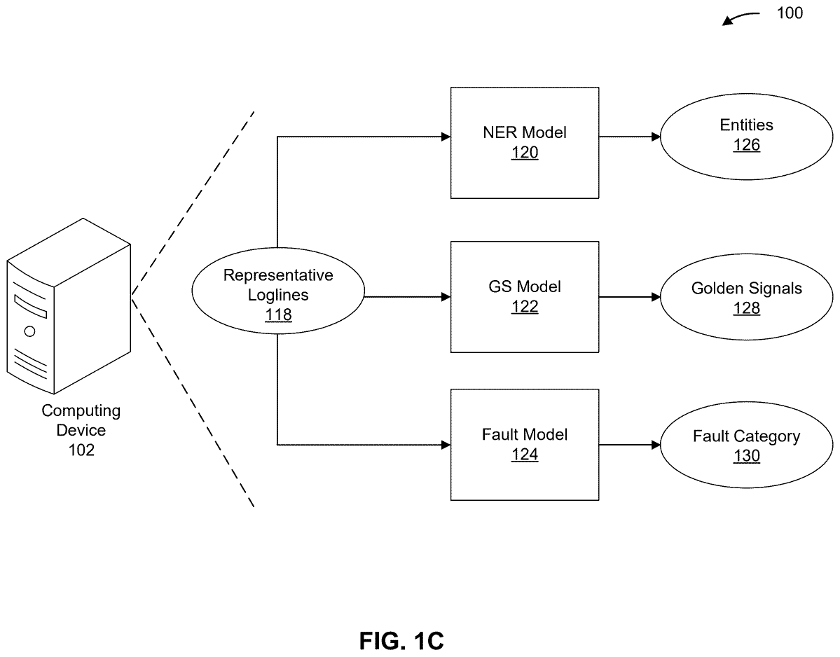

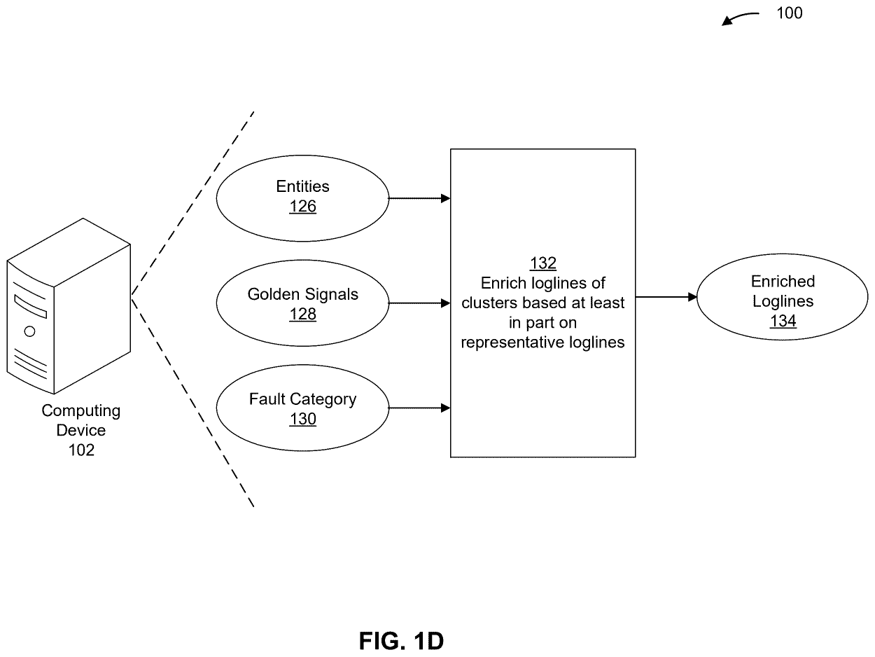

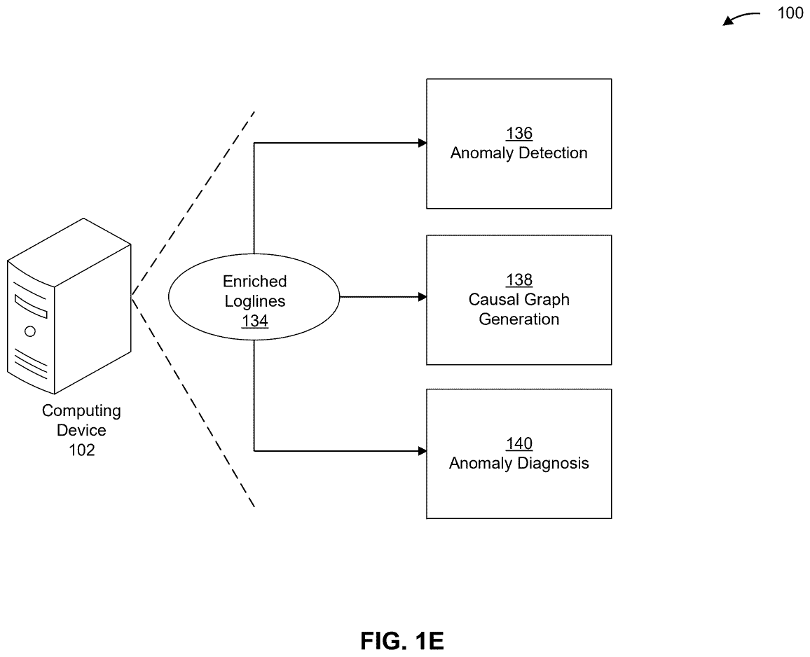

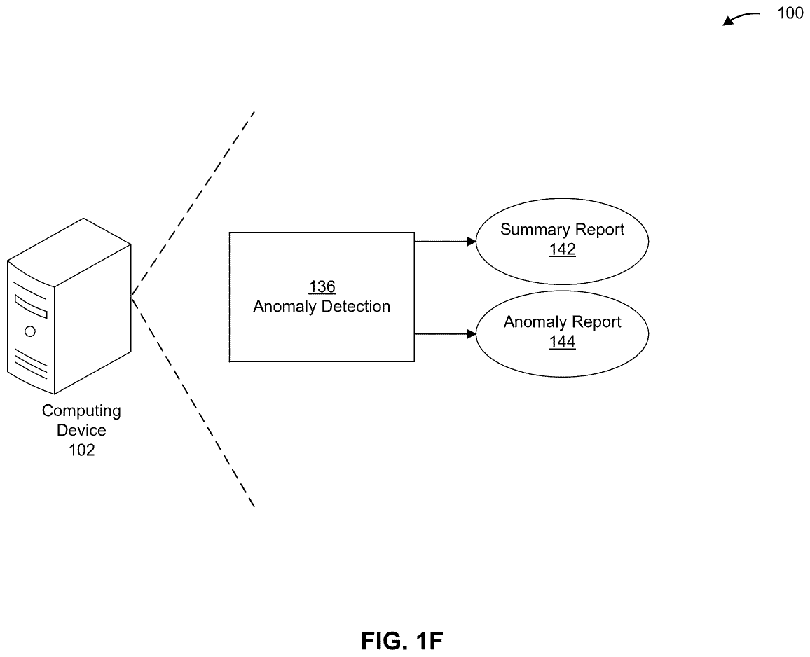

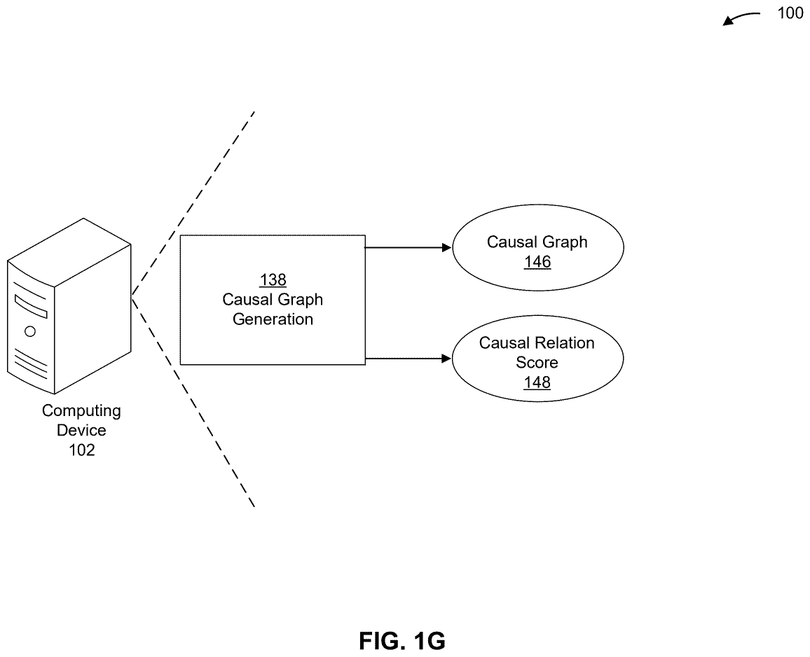

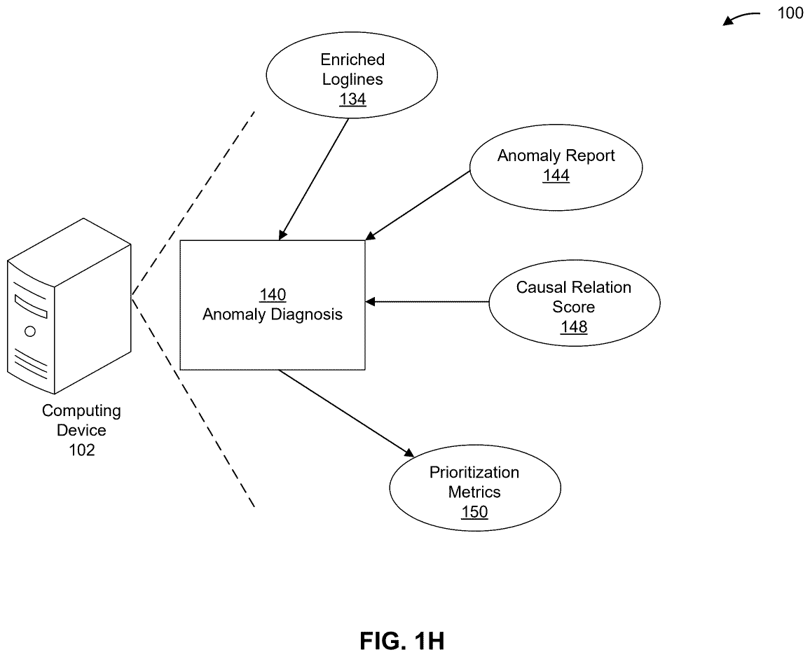

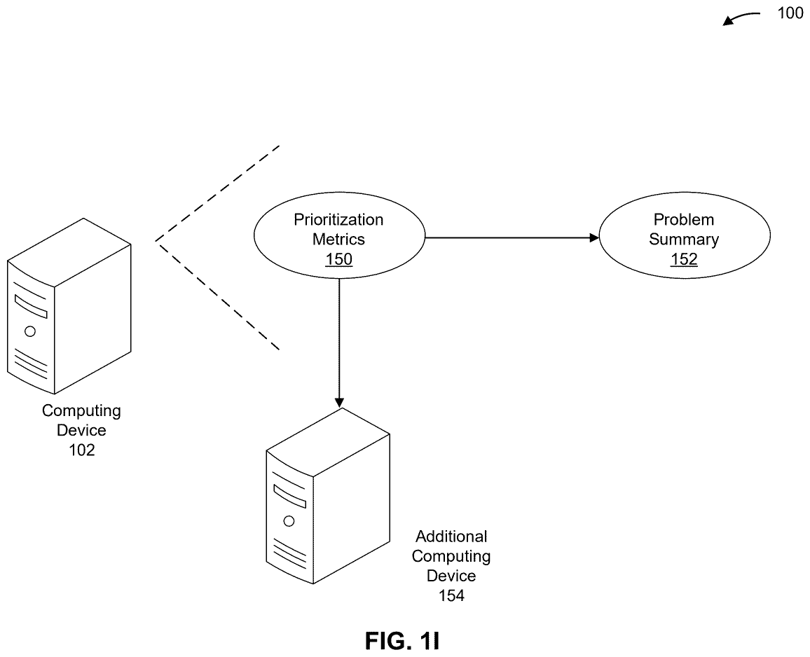

FIGS. 1A-1I are diagrams of an example implementation 100 described herein. As shown in FIGS. 1A-1I, example implementation 100 includes a computing device 102 that may perform logline enrichment for error analysis. In some aspects, the computing device 102 may be configured with a communication component to communicate with other computing devices. Additionally, or alternatively, the computing device 102 may be configured with an input component to receive input from a user or an output component to provide information to a user (e.g., a display or speaker, among other examples).

FIG. 1A shows an example implementation 100. As shown in FIG. 1A, the computing device 102 may receive a problem description 104 and a data dump 106. In some aspects, the computing device 102 may receive the problem description 104 via input from a user or from a computing system. In some aspects, the computing device 102 may receive the data dump 106 via an application programming interface local to the computing device 102 or via another computing device.

In some aspects, the computing device 102 may receive the problem description 104 and the data dump 106 within a ticket. In some aspects, the data dump 106 comprises multiple folders and multiple files. In some aspects, the computing device 102 may receive an architecture diagram showing several components or services and interactions between them, in associated with the data dump 106. In some aspects, the data dump 106 may include release notes for components associated with the problem description 104 or the data dump 1-6, which release notes may include or indicate associated files.

As shown by reference number 108, the computing device may detect relevant files associated with the problem that is associated with the problem description 104. In some aspects, the computing device 102 may use prompt engineering to define a prompt with contextual information as a summary of components to predict one or more relevant file names. In some aspects, the prompt engineering may include preparation of few-shot training examples to teach an artificial intelligence (AI) generative model to generate one or more pod-names or service names that may be associated with the ticket description.

As shown by reference number 110, the computing device 102 may select a set of loglines associated with the problem. For example, the computing device 102 may use the prompt engineering or the AI generative model to identify the set of loglines associated with the problem.

As shown in FIG. 1B, and by reference number 112, the computing device 102 may templatize the loglines of the set of loglines. For example, the computing device 102 may identify common fields and variable fields among groups of the loglines.

As shown by reference number 114, the computing device 102 may identify clusters of the loglines. For example, the computing device 102 may group loglines having a same template into a cluster. In some aspects, the computing device 102 may form multiple clusters within the set of loglines.

As shown by reference number 116, the computing device 102 may identify representative loglines within the clusters. For example, the computing device 102 may identify one logline of a cluster or multiple loglines of the cluster as a subset of the cluster. In some aspects, the computing device 102 may choose a representative logline randomly, based on an order (e.g., first or last in the cluster based at least in part on timing, alphabetical, or other ordering), or configured rule, among other examples.

As shown in FIG. 1C, the computing device 102 may generate the representative loglines 118 (e.g., one per cluster or multiple per cluster). In some aspects, the computing device 102 may provide the representative loglines 118 to one or more of a named entity recognition (NER) model 120, a GS model 122, or a fault model 124.

In some aspects, the computing device 102 may use the NER model 120 to identify computer-based entities 126 associated with the representative loglines 118. In some aspects, the computing device 102 may utilize a labelled dataset D1 that is specifically designed for classifying named entity recognition. Dataset D1 may include loglines, with each logline labelled (e.g., manually) with named entities at a token level by a human. The computing device may fine-tune a Bert model using dataset D1, which helps improve performance in identifying and classifying named entities. At runtime, the fine-tuned Bert model may be employed to determine the named entities associated with a given logline.

In some aspects, the computing device 102 may use the GS model 122 to identify GSs 128. In some aspects, GSs 128 include an indication of one or more of six GSs: error, availability, latency, saturation, traffic, or information. In some aspects, the computing device 102 may utilize a labelled dataset D2, which is specifically designed for classifying GSs. Dataset D2 consists of log lines, and each log line has been manually labelled with a GS by a human. As with the NER model 120, the computing device 102 may fine-tune the Bert model using dataset D2 to improve performance in identifying GSs. At runtime, the fine-tuned Bert model may be employed to determine the GS associated with a given logline.

In some aspects, the computing device may use the fault model 124 to identify a fault category 130 within the representative loglines 118. The fault category 130 may indicate a level at which a fault has occurred within a computing system. Similar to the NER model 120 and the GS model 122, the computing device 102 may utilize a labelled dataset D3 that is specifically designed for classifying fault categories. Dataset D3 may include loglines where each log line has been manually labelled with one or more fault category by a human. The computing device 102 may fine-tune the Bert model using dataset D3 to improve performance in identifying fault category. At runtime, the fine-tuned Bert model may be employed to determine fault categories associated with a given logline.

In some aspects, one or more of the entities 126, the GSs 128, or the fault categories 130 may be referred to as key indicators associated with the representative loglines (e.g., a subset of loglines of a cluster). Similarly, when attached to the loglines, or provided as additional data or metadata, indications of one or more of the entities 126, the GSs 128, or the fault categories 130 may be referred to as enrichment data.

As shown in FIG. 1D, and by reference number 132, the computing device 102 may use the entities 126, the GSs 128 and the fault categories 130 to enrich loglines of clusters based at least in part on representative loglines. For example, a first logline may be a representative logline for a first cluster and a second logline may be a representative logline for a second cluster. The first logline may have first entities 126, first golden signals 128, and a first fault category 130. The second logline may have second entities 126, second golden signals 128, and a second fault category 130. The computing device 102 may enrich the first cluster by applying the first entities 126, the first golden signals 128, and the first fault category 130 to loglines of the first cluster. Similarly, the computing device 102 may enrich the second cluster by applying the second entities 126, the second golden signals 128, and the second fault category 130 to loglines of the second cluster.

In this way, the computing device 102 may generate enriched loglines 134 based at least in part on analyzing only a subset of loglines (e.g., one representative logline) within the clusters of loglines. This may conserve computing and power resources that may have otherwise been consumed by analyzing each of the loglines of the set of loglines. Additionally, this may reduce a latency of generating the data, which may reduce an amount of time the computing device 102 or other computing device operates in with an uncorrected error.

As shown in FIG. 1E, the computing device 102 may provide the enriched loglines 134 (e.g., including one or more of the entities 126, the GSs 128, or the fault categories 130) for anomaly detection 136, causal graph generation 138, or anomaly diagnosis 140. In this way, the computing device 102 may use the key indicators to provide additional information to an error correction engineer to improve error detection and correction and to reduce wasteful consumption of power and computing resources.

As shown in FIG. 1F, the computing device 102 may use anomaly detection 136, using enriched loglines, to generate a summary report 142 and an anomaly report 144. In some aspects, the computing device 102 may use GS and fault category key indicators to generate the summary report and the anomaly report.

In some aspects, the computing device 102 may perform anomaly detection by using 30-second windowing of the loglines. For example, a dataset D4, including N log lines, may be divided into 30-second windows. The computing device 102 may enrich windows (e.g., each window) by appending corresponding GS and fault categories to log lines (e.g., each lot line) within a 30-second window is enhanced by appending the corresponding golden signal and fault categories. For example, a logline of “HTTP 404 error has occurred in the application running on node 4x0dg” may be enriched to “HTTP 404 error has occurred in the application running on node 4x0dg. Golden Signal: error. Fault Categories: application, device.”

The computing device 102 may further provide labelling to the loglines. For example, a 30-second window may be marked as anomaly or non-anomaly window by a human labeller based at least in part on constituting enriched loglines. The dataset resulting from this process may be referred to as an enriched anomaly detection dataset E.

Utilizing the labelled dataset E, the computing device 102 or other computing device may train an anomaly detection model. The computing device 102 or other computing device may enhance performance of the Bert model by fine-tuning it using dataset E, enabling improved identification of anomaly time windows. During runtime, client data may be segmented into 30-second windows and respective windows may be enriched following the same process as dataset E. The fine-tuned Bert model may be employed to detect anomalous 30-second windows in the client data. The identified anomalous 30-second windows may be stored in a dedicated database (e.g., referred to as “DB-2.”). When a user (e.g., error correction engineer) inputs a predefined or custom time range into the system, a query may be executed on the dedicated database to retrieve all anomalous 30-second windows within the specified time range.

In some aspects, an error correction engineer may use a microscopic view of anomalous windows in a summary report. In some examples, GS, fault category, and named entities may be predicted for individual loglines within an anomalous window. The computing device 102 may receive, from a user, a request to apply a filter on the loglines based on a specific GS and fault category. A microscopic view empowers the error correction engineer to identify what kind of anomaly has happened (e.g., from the GS), cues in a logline context for the anomaly (e.g., from the named entities), and at what level in the system the anomaly has occurred (e.g., from the fault category).

As shown in FIG. 1G, the computing device 102 may use the causal graph generation 138 to generate a causal graph 146 and a causal relation score 148. In some aspects, the computing device 102 or another computing device may perform the causal graph generation based at least in part on having groups of coherent loglines (e.g., based at least in part on the templatization). For a cluster (e.g., group), the computing device 102 may retain groups that have GS and fault categories associate with the groups. For each template, the computing device 102 may create a template time series based at least in part on aggregating a number of loglines for each template in each interval of time. The computing device 102 may ignore templates that do not belong to any anomalous windows and may use the causal inference technique to infer causal relationships between each pair of templates. In this way, the causal graph 146 may include information regarding the type problem (e.g., based at least in part on the GS) along with causality between problems. The computing device 102 may enrich a logline by including the causal relationships with the mapped templates (e.g., from templatization and clustering). In some aspects, the causal relation score may be based at least in part on how many problems to which a logline is associated or a location in a relationship hierarchy.

As shown in FIG. 1H, the computing device 102 may use one or more of the enriched loglines 134, the anomaly report 144, or the causal relation score 148 to generate prioritization metrics 150. In some aspects, the computing device 102 or another computing device may use a signal computed earlier for a logline to produce a score that represents an importance of an associated window with respect to issue diagnosis. In some aspects, the computing device 102 or another computing device may compute issue diagnosis score based at least in part on a golden score (e.g., associated with the GSs), a fault category score, an entity-level score, or a causal relationship score.

In some aspects, the golden score may be based at least in part on an importance level assigned to each GS. The importance level may be provided by another computing device (e.g., an external device). The computing device 102 may assign an importance level as the golden score. The fault category score may be based at least in part on an importance level assigned to each fault category, which may be provided by another computing device. The entity-level score may be based at least in part on an importance level assigned to each entity, which may be provided by another computing device. The computing device 102 may calculate an average of the entity-level scores associated with entities identified in the loglines and may assign importance as the entity-level score.

The computing device may compute causal relationship score based at least in part on counting a number of other issues that a fault associated with a logline is causing. The count may be the causal relationship score.

In some aspects, a total (e.g., final) score may be used to rank windows for importance or priority as the prioritization metrics 150.

As shown in FIG. 1I, the computing device 102 may use the prioritization metrics 150 to generate a problem summary 152. For example, the computing device 102 may generate a description of a cause of an error, such as “error occurred due to unavailability of metadata for repo ‘afmdr’ causing application and network faults.”

The computing device 102 may further provide the prioritization metrics 150 to an additional computing device 154. In some aspects, the additional computing device 102 may be associated with an error correction engineer that may use the prioritization metrics to discover an error and correct the error while consuming fewer computing and power resources than within the prioritization metrics. Additionally, the error correction engineer may correct the error with reduced latency, which may reduce an amount of time that a computing system operates with the error and reduce an amount of computing, power, and storage resources associated with operating with the error.

As indicated above, FIGS. 1A-1I are provided as an example. Other examples may differ from what is described with regard to FIGS. 1A-1I. The number and arrangement of devices shown in FIGS. 1A-1I are provided as an example.

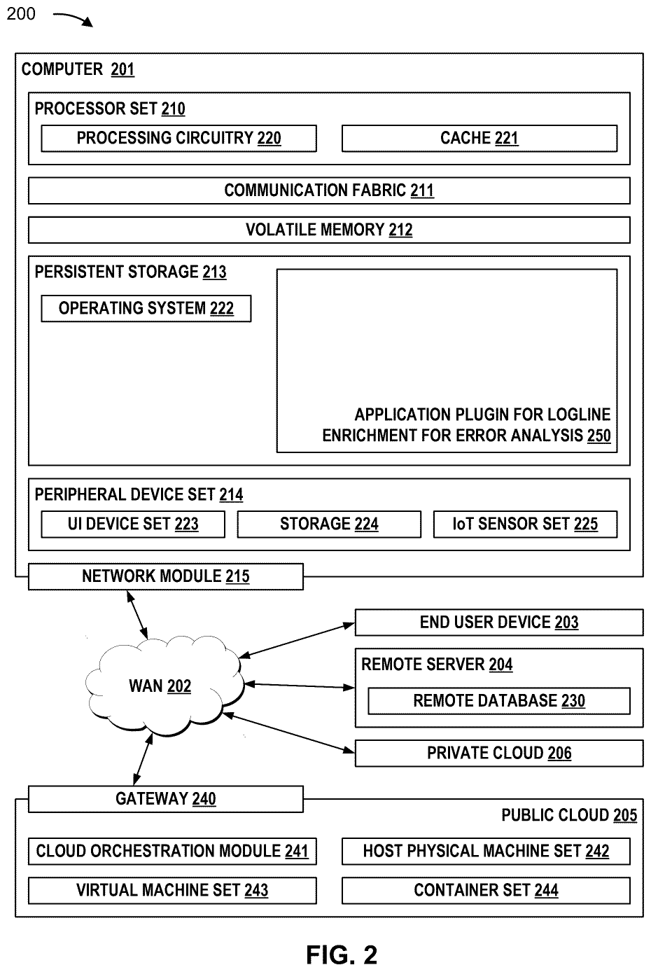

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as application plugin for logline enrichment for error analysis 250. In addition to application plugin for logline enrichment for error analysis 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and application plugin for logline enrichment for error analysis 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in application plugin for logline enrichment for error analysis 250 in persistent storage 213.

Communication fabric 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in application plugin for logline enrichment for error analysis 250 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

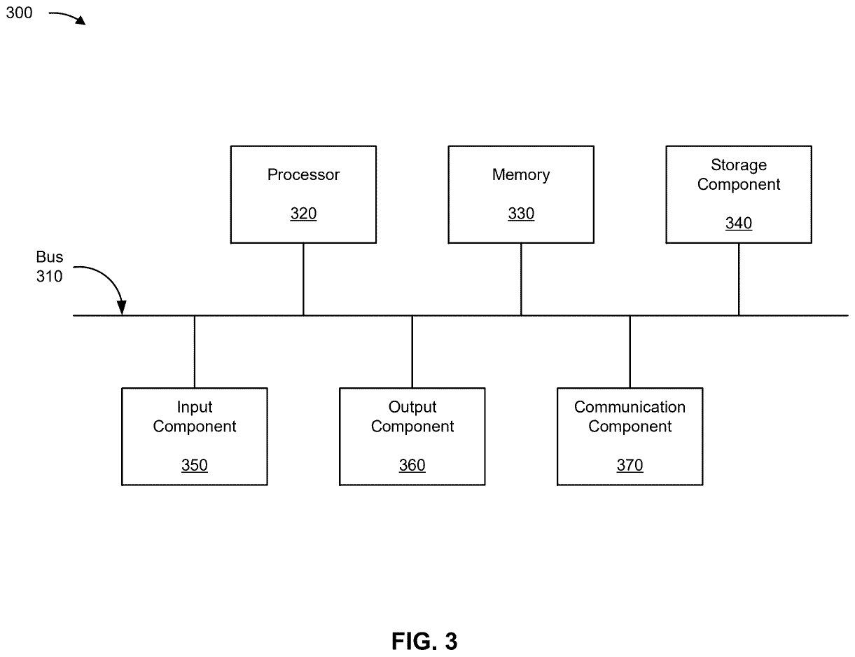

FIG. 3 is a diagram of example components of a device 300, which may correspond to the computing device 105, among other examples. In some implementations, the computing device 105 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may be a repository that stores a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

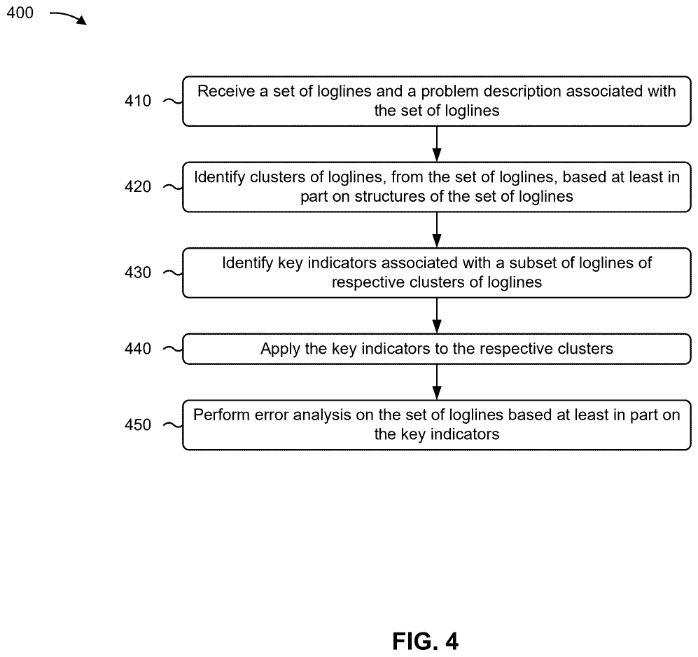

FIG. 4 is a flowchart of an example process 400 associated with logline enrichment for error analysis. In some implementations, one or more process blocks of FIG. 4 may be performed by a computing device (e.g., computing device 105). In some implementations, one or more process blocks of FIG. 4 may be performed by another device or a group of devices separate from or including the computing device, such as a network computing device, an application server, or a personal computing device. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving a set of loglines and a problem description associated with the set of loglines (block 410). For example, the computing device may receive a set of loglines and a problem description associated with the set of loglines, as described above.

As further shown in FIG. 4, process 400 may include identifying clusters of loglines, from the set of loglines, based at least in part on structures of the set of loglines (block 420). For example, the computing device may identify clusters of loglines, from the set of loglines, based at least in part on structures of the set of loglines, as described above.

As further shown in FIG. 4, process 400 may include identifying key indicators associated with a subset of loglines of respective clusters of loglines (block 430). For example, the computing device may identify key indicators associated with a subset of loglines of respective clusters of loglines, as described above.

As further shown in FIG. 4, process 400 may include applying the key indicators to the respective clusters (block 440). For example, the computing device may apply the key indicators to the respective clusters, as described above.

As further shown in FIG. 4, process 400 may include performing error analysis on the set of loglines based at least in part on the key indicators (block 450). For example, the computing device may perform error analysis on the set of loglines based at least in part on the key indicators, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

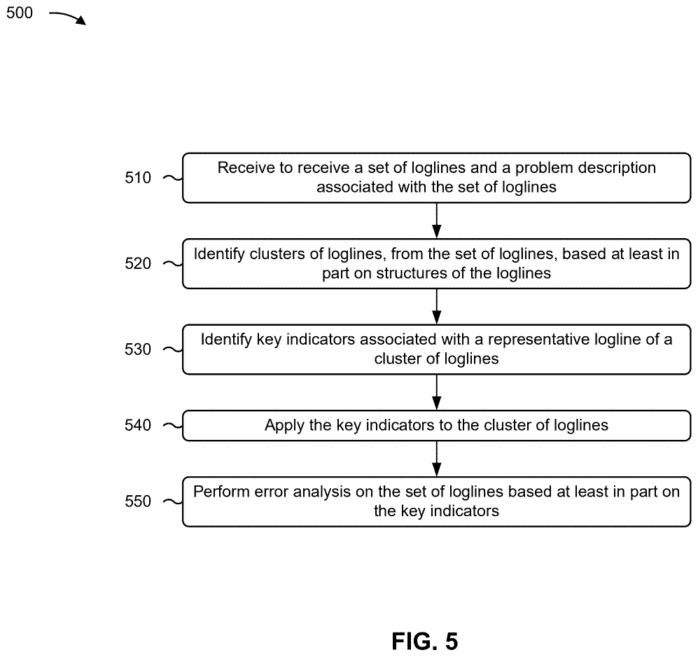

FIG. 5 is a flowchart of an example process 500 associated with logline enrichment for error analysis. In some implementations, one or more process blocks of FIG. 5 may be performed by a computing device (e.g., computing device 105). In some implementations, one or more process blocks of FIG. 5 may be performed by another device or a group of devices separate from or including the computing device, such as a network computing device, an application server, or a personal computing device. Additionally, or alternatively, one or more process blocks of FIG. 5 may be performed by one or more components of device 300, such as processor 320, memory 330, storage component 340, input component 350, output component 360, and/or communication component 370.

As shown in FIG. 5, process 500 may include receiving to receive a set of loglines and a problem description associated with the set of loglines (block 510). For example, the computing device may receive to receive a set of loglines and a problem description associated with the set of loglines, as described above.

As further shown in FIG. 5, process 500 may include identifying clusters of loglines, from the set of loglines, based at least in part on structures of the loglines (block 520). For example, the computing device may identify clusters of loglines, from the set of loglines, based at least in part on structures of the loglines, as described above.

As further shown in FIG. 5, process 500 may include identifying key indicators associated with a representative logline of a cluster of loglines (block 530). For example, the computing device may identify key indicators associated with a representative logline of a cluster of loglines, as described above.

As further shown in FIG. 5, process 500 may include applying the key indicators to the cluster of loglines (block 540). For example, the computing device may apply the key indicators to the cluster of loglines, as described above.

As further shown in FIG. 5, process 500 may include performing error analysis on the set of loglines based at least in part on the key indicators (block 550). For example, the computing device may perform error analysis on the set of loglines based at least in part on the key indicators, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

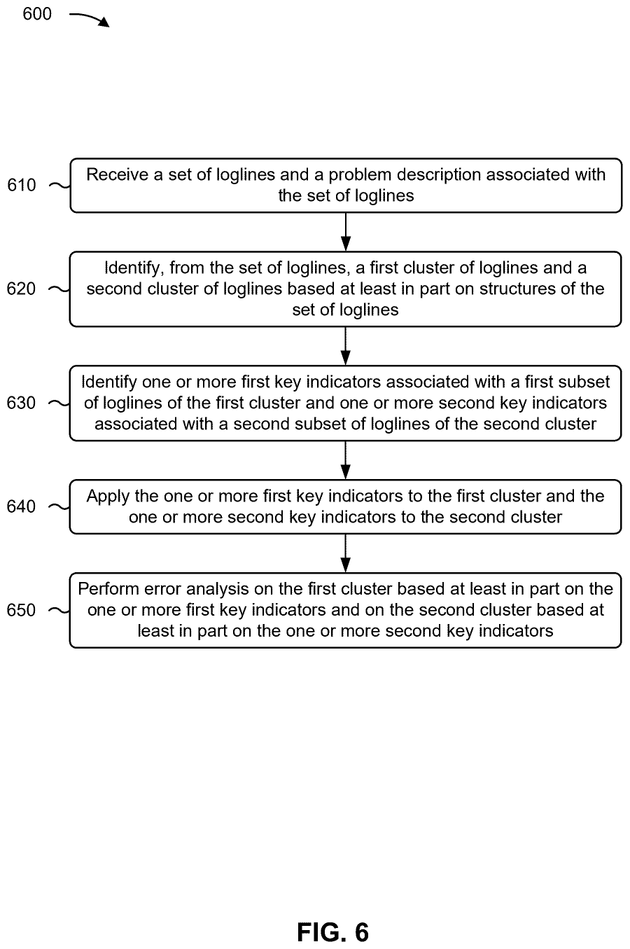

FIG. 6 is a flowchart of an example process 600 associated with logline enrichment for error analysis. In some implementations, one or more process blocks of FIG. 6 may be performed by a computing device (e.g., computing device 105). In some implementations, one or more process blocks of FIG. 6 may be performed by another device or a group of devices separate from or including the computing device, such as a network computing device, an application server, or a personal computing device. Additionally, or alternatively, one or more process blocks of FIG. 6 may be performed by one or more components of device 300, such as processor 320, memory 330, storage component 340, input component 350, output component 360, and/or communication component 370.

As shown in FIG. 6, process 600 may include receiving a set of loglines and a problem description associated with the set of loglines (block 610). For example, the computing device may receive a set of loglines and a problem description associated with the set of loglines, as described above.

As further shown in FIG. 6, process 600 may include identifying, from the set of loglines, a first cluster of loglines and a second cluster of loglines based at least in part on structures of the set of loglines (block 620). For example, the computing device may identify, from the set of loglines, a first cluster of loglines and a second cluster of loglines based at least in part on structures of the set of loglines, as described above.

As further shown in FIG. 6, process 600 may include identifying one or more first key indicators associated with a first subset of loglines of the first cluster and one or more second key indicators associated with a second subset of loglines of the second cluster (block 630). For example, the computing device may identify one or more first key indicators associated with a first subset of loglines of the first cluster and one or more second key indicators associated with a second subset of loglines of the second cluster, as described above.

As further shown in FIG. 6, process 600 may include applying the one or more first key indicators to the first cluster and the one or more second key indicators to the second cluster (block 640). For example, the computing device may apply the one or more first key indicators to the first cluster and the one or more second key indicators to the second cluster, as described above.

As further shown in FIG. 6, process 600 may include performing error analysis on the first cluster based at least in part on the one or more first key indicators and on the second cluster based at least in part on the one or more second key indicators (block 650). For example, the computing device may perform error analysis on the first cluster based at least in part on the one or more first key indicators and on the second cluster based at least in part on the one or more second key indicators, as described above.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Processes 400, 500, or 600 may include additional implementations, such as any single implementation or any combination of implementations described below and/or in connection with one or more other processes described elsewhere herein.

In a first implementation, the subset of loglines of respective clusters of loglines comprises a single representative logline for a cluster of loglines.

In a second implementation, alone or in combination with the first implementation, the key indicators are associated with one or more of entities of the subset of loglines, golden signals of the subset of loglines, or a fault category of the subset of loglines.

In a third implementation, alone or in combination with one or more of the first and second implementations, performing error analysis on the set of loglines comprises performing anomaly detection based at least in part on golden signal and fault category key indicators.

In a fourth implementation, alone or in combination with one or more of the first through third implementations, process 400, 500, or 600 includes generating a summary report based at least in part on anomaly detection, or generating an anomaly report having loglines enriched with the key indicators.

In a fifth implementation, alone or in combination with one or more of the first through fourth implementations, performing error analysis on the set of loglines comprises generating a causal graph based at least in part on a golden signal key indicator.

In a sixth implementation, alone or in combination with one or more of the first through fifth implementations, performing error analysis on the set of loglines comprises generating a diagnosis score based at least in part on one or more of an anomaly report that is based at least in part on the key indicators, a causal relation score that is based at least in part on the key indicators, or an entity score that is based at least in part on the key indicators.

In a seventh implementation, alone or in combination with one or more of the first through sixth implementations, process 400, 500, or 600 includes indicating prioritization metrics for the set of loglines based at least in part on the diagnosis score.

In an eighth implementation, alone or in combination with one or more of the first through seventh implementations, process 400, 500, or 600 includes selecting relevant files from a dump of telemetry data, the relevant files being relevant based at least in part on association with the problem description, and selecting the set of loglines based at least in part on selecting the relevant files.

In a ninth implementation, alone or in combination with one or more of the first through eighth implementations, respective clusters of loglines are associated with different logline templates.

In a tenth implementation, alone or in combination with one or more of the first through ninth implementations, process 400, 500, or 600 includes inferring causal relationships between pairs of logline templates based at least in part on both being in a window of time associated with an anomaly.

In addition to the implementations described above, elements described in connection with any of processes 400, 500, or 600 may be combined with elements of another of processes 400, 500, or 600.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a set of loglines and a problem description associated with the set of loglines;
identifying clusters of loglines, from the set of loglines, based at least in part on structures of the set of loglines;
identifying key indicators associated with a subset of loglines of respective clusters of loglines;
applying the key indicators to the respective clusters; and
performing error analysis on the set of loglines based at least in part on the key indicators.

2. The method of claim 1, wherein the subset of loglines of respective clusters of loglines comprises:
a single representative logline for a cluster of loglines.

3. The method of claim 1, wherein the key indicators are associated with one or more of:
entities of the subset of loglines,
golden signals of the subset of loglines, or a fault category of the subset of loglines.

4. The method of claim 1, wherein performing error analysis on the set of loglines comprises:
performing anomaly detection based at least in part on golden signal and fault category key indicators.

5. The method of claim 4, further comprising:
generating a summary report based at least in part on anomaly detection, or
generating an anomaly report having loglines enriched with the key indicators.

6. The method of claim 1, wherein performing error analysis on the set of loglines comprises:
generating a causal graph based at least in part on a golden signal key indicator.

7. The method of claim 1, wherein performing error analysis on the set of loglines comprises generating a diagnosis score based at least in part on one or more of
an anomaly report that is based at least in part on the key indicators,
a causal relation score that is based at least in part on the key indicators, or an entity score that is based at least in part on the key indicators.

8. The method of claim 7, further comprising:
indicating prioritization metrics for the set of loglines based at least in part on the diagnosis score.

9. The method of claim 1, further comprising:
selecting relevant files from a dump of telemetry data, the relevant files being relevant based at least in part on association with the problem description; and
selecting the set of loglines based at least in part on selecting the relevant files.

10. The method of claim 1, wherein respective clusters of loglines are associated with different logline templates.

11. The method of claim 10, further comprising:
inferring causal relationships between pairs of logline templates based at least in part on both being in a window of time associated with an anomaly.

12. A computer program product comprising:
one or more computer readable storage media, and program instructions collectively stored on the one or more computer readable storage media, the program instructions comprising:
program instructions to receive a set of loglines and a problem description associated with the set of loglines;
program instructions to identify clusters of loglines, from the set of loglines, based at least in part on structures of the loglines;
program instructions to identify key indicators associated with a representative logline of a cluster of loglines;
program instructions to apply the key indicators to the cluster of loglines; and
program instructions to perform error analysis on the set of loglines based at least in part on the key indicators.

13. The computer program product of claim 12, wherein the key indicators are associated with one or more of:
entities of the subset of loglines,
golden signals of the subset of loglines, or
a fault category of the subset of loglines.

14. The computer program product of claim 12, wherein, to perform error analysis on the set of loglines, the program instructions comprise one or more of:
program instructions to perform anomaly detection based at least in part on golden signal and fault category key indicators;
program instructions to generate a causal graph based at least in part on a golden signal key indicator; or
program instructions to generate a diagnosis score based at least in part on one or more of
an anomaly report that is based at least in part on the key indicators,
a causal relation score that is based at least in part on the key indicators, or
an entity score that is based at least in part on the key indicators.

15. The computer program product of claim 14, wherein the program instructions comprise:
program instructions to indicate prioritization metrics for the set of loglines based at least in part on the diagnosis score.

16. The computer program product of claim 14, wherein, to perform anomaly detection, the program instructions comprise:
program instructions to generate a summary report based at least in part on anomaly detection, or
program instructions to generate an anomaly report having loglines enriched with the key indicators.

17. The computer program product of claim 14, wherein, to generate the causal graph, the program instructions comprise:
program instructions to infer causal relationships between pairs of logline templates, associated with respective clusters of loglines, based at least in part on both being in a window of time associated with an anomaly.

18. The computer program product of claim 12, wherein the program instructions comprise:
program instructions to receive the problem description associated with the set of loglines;
program instructions to select relevant files from a dump of telemetry data, the relevant files being relevant based at least in part on association with the problem description; and
selecting the set of loglines based at least in part on selecting the relevant files.

19. A system comprising:
one or more devices configured to:
receive a set of loglines and a problem description associated with the set of loglines;
identify, from the set of loglines, a first cluster of loglines and a second cluster of loglines based at least in part on structures of the set of loglines;
identify one or more first key indicators associated with a first subset of loglines of the first cluster and one or more second key indicators associated with a second subset of loglines of the second cluster;
apply the one or more first key indicators to the first cluster and the one or more second key indicators to the second cluster; and
perform error analysis on the first cluster based at least in part on the one or more first key indicators and on the second cluster based at least in part on the one or more second key indicators.

20. The system of claim 19, wherein the one or more devices are configured to:
provide the error analysis to a computing device associated with error correction.
